(19) United States
(12) Patent Application Publication
(10) Pub. No.: US 2009/0222633 A1
(43) Pub. Date: Sep. 3, 2009

(54) INFORMATION PROCESSING SYSTEM AND INFORMATION PROCESSING METHOD CAPABLE OF PERFORMING DETAILED STATE NOTIFICATION EVEN IN A DIFFICULT SITUATION

(76) Inventor: TAKEO MIYAJIMA, Kanagawa (JP)

Correspondence Address: NEC CORPORATION OF AMERICA, 6535 N. STATE HWY 161, IRVING, TX, 75039, US

(21) Appl. No.: 12/392,720

(22) Filed: Feb. 25, 2009

(30) Foreign Application Priority Data
Feb. 29, 2008 (JP) 2008-049991

(51) Int. Cl. G06F 9/30; G06F 12/16

(52) U.S. Cl. 711/162; 712/220; 711/E12.103; 712/E09.016

(57) ABSTRACT

In an information processing system having a main central processing unit for processing object information being a processing object, a sub-central processing unit adapted to operate independently of the main central processing unit is further provided. The main central processing unit produces execution information indicating executing contents and a corresponding time point. The sub-central processing unit processes state information indicating a state of the information processing system while receiving the execution information.

This application is based upon and claims the benefit of priority from Japanese patent application No. 2008-049991, filed on Feb. 29, 2008, the disclosure of which is incorporated herein in its entirety by reference.

### TECHNICAL FIELD

This invention relates to an information processing system, an information processing method, and a computer program therefor.

### BACKGROUND ART

In a general computer system, a startup program is sequentially executed after power-on of the system. Normally, this startup program performs initialization of respective devices constituting the computer system and conducts a test as to whether or not each device can continue to operate stably and, after the executed contents are all judged to be normal, it transfers the control to an operating system (OS). Thereafter, the computer system continues to operate under the control of the OS.

If, for example, the initialization is not completed normally or the test is finished abnormally in the above process, a method is generally employed to shift to error processing. However, in this case, from the exterior, it appears to be a phenomenon such that the computer system is not set to an operable state indefinitely or, in the case of the computer system being an apparatus having a display, such as a personal computer, a state with no screen display continues.

When such a situation occurs, notification is made to the exterior as to where a problem exists in the computer system, or a failure or abnormality about a hard disk of the computer system is detected, analyzed, and recorded. Related arts of the latter are disclosed in, for example, Japanese Unexamined Patent Application Publications (JP-A) Nos. 2007-172096, Hei 02-190945, and Hei 09-170932.

### SUMMARY OF THE INVENTION

However, failure analysis according to the above related arts has the following problems.

At first, since state notification is performed in a simple manner, the amount of information obtained therefrom is very small and thus it is quite difficult to identify a cause of a failure only based on the obtained information. For example, when a problem occurs in a main memory, while only a phenomenon that NG (failure) has occurred in a memory test is displayed with a simple code, it is often not possible to obtain information about an address value thereof or about what data was written.

Further, when there is a problem in a main CPU or I/O itself, the startup is disabled while notification to the exterior cannot be performed at all and thus a long-time analysis operation is required for clearing up the cause.

It is therefore an exemplary object of this invention to provide an information processing system, an information processing method, and a computer program capable of performing detailed state notification even in a situation where it is difficult for an operator to identify contents of a failure from the exterior such as upon occurrence of a failure immediately after the system startup.

Other objects of the present invention will become clear as the description proceeds.

According to an exemplary aspect of the present invention, there is provided an information processing system which comprises a main central processing unit that executes processing of object information being a processing object and produces execution information indicating executing contents and a corresponding time point, and a sub-central processing unit that is connected to the main central processing unit, operates independently of the main central processing unit, and processes state information indicating a state of the information processing system while receiving the execution information.

According to another exemplary aspect of the present invention, there is provided an information processing method in an information processing system comprising a main central processing unit for processing object information being a processing object. The method comprises preparing a sub-central processing unit adapted to operate independently of the main central processing unit, causing the main central processing unit to produce execution information indicating executing contents and a corresponding time point, and causing the sub-central processing unit to process state information indicating a state of the information processing system while receiving the execution information.

According to still another exemplary aspect of the present invention, there is provided a computer program for operating an information processing system comprising a main central processing unit for processing object information being a processing object and a sub-central processing unit adapted to operate independently of the main central processing unit. The computer program comprises the steps of causing the main central processing unit to produce execution information indicating executing contents and a corresponding time point and of causing the sub-central processing unit to process state information indicating a state of the information processing system while receiving the execution information.

An exemplary effect of the present invention is that it is possible to perform detailed state notification even in a situation where it is difficult for an operator to identify contents of a failure from the exterior such as upon occurrence of a failure immediately after the system startup.

### BRIEF DESCRIPTION OF THE DRAWINGS

FIG. 1 is a block diagram of a computer system as one example of an information processing system according to an exemplary embodiment of this invention; and

FIG. 2 is a block diagram of a computer system according to a related art.

### DESCRIPTION OF THE EXEMPLARY EMBODIMENT

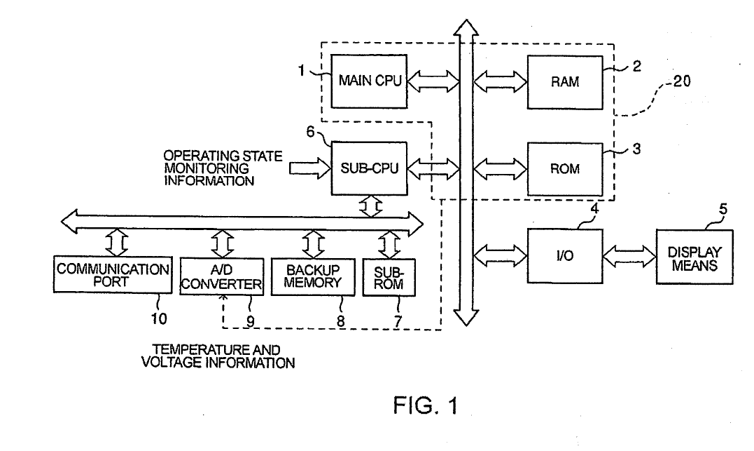

Referring to FIG. 1, an information processing system according to an exemplary embodiment of this invention will be described using a computer system.

The computer system of FIG. 1 comprises a main CPU 1, a RAM 2 and a ROM 3 each connected to the main CPU 1, and a circuit board 20 with at least these components mounted thereon. The main CPU 1 is a main central processing unit of the computer system and processes object information being a processing object. The RAM 2 is a main storage device for temporarily storing instructions and data necessary for arithmetic operations and control by the main CPU 1. The ROM 3 is a non-volatile storage device storing a startup program which is read by the main CPU 1.

The main CPU 1 sequentially reads instructions and data from the ROM 3 and executes initialization and tests necessary for the system startup. Generally, for speeding up the processing, there are instances where the main CPU 1 does not directly read instructions and data from the ROM 3, but once copies and transfers them to the RAM 2 and reads them from the RAM 2.

The computer system of FIG. 1 further comprises I/O means 4 connected to the main CPU 1 and display means 5 connected to the I/O means 4. The I/O means 4 is means for outputting, to the exterior, codes that are output according to the progress of execution of the startup program by the main CPU 1. The display means 5 is a display device for displaying those codes. The I/O means 4 is a general input/output device, but is not a device dedicated for displaying the above startup program execution progress.

The computer system of FIG. 1 further comprises a sub-CPU (sub-central processing unit) 6, a sub-ROM (sub-storage device) 7, a backup memory 8, an A/D converter (input means) 9, and a communication port 10. The sub-CPU 6 operates according to a control program stored in the sub-ROM 7 so that it receives state notification from the main CPU 1 as a message, analyzes the message, and logs an analysis result into the backup memory 8. The sub-CPU 6 is a CPU that operates completely independently of the main CPU 1 and is capable of even controlling by itself the communication port 10 according to need so as to output log information through the communication port 10.

The backup memory 8 is a volatile storage device backed up by a battery or the like even if the power supply on the circuit board 20 is disconnected, or a non-volatile storage device. The A/D converter 9 monitors the temperature on the circuit board 20 and voltage values at respective portions and successively notifies the sub-CPU 6 of digital values corresponding to those monitored values. Further, the A/D converter 9 serves to monitor states of control signals, such as a clock signal and a reset signal, important for the system startup. The communication port 10 operates under the control of the sub-CPU 6. The sub-CPU 6 receives a command from the main CPU 1 and outputs information logged in the backup memory 8 through the communication port 10.

The sub-ROM 7 and the A/D converter 9 may be incorporated in the sub-CPU 6. Further, although FIG. 1 shows the configuration where the main CPU 1, the RAM 2, the ROM 3, the I/O means 4, and the sub-CPU 6 all share a common system bus, there is also a case where a CPU bus and an I/O bus are separated because of CPU speedup in recent years, thus not limited to the illustrated bus configuration.

Since the main CPU 1, the RAM 2, the ROM 3, and the I/O means 4 are general computer system components and thus are well known to a person skilled in the art and further are not directly related to this invention, detailed explanation thereof is omitted.

Now, the operation of the computer system of FIG. 1 will be described. Naturally, the computer system performs the operation according to a computer program which will be clear from the following description.

It is assumed that the circuit board 20 is powered on and the main CPU 1 has started execution of a startup program. This startup program mainly aims to perform initial setting of the respective semiconductor devices on the circuit board 20 and to conduct a test of each device for the purpose of booting an operating system (OS) with no problem later. Therefore, the startup program is in the form of a necessary minimum program for normally starting up the system and thus is not a program for achieving the function and object of the computer system. For example, in an apparatus like a general personal computer, it is a boot program to be processed prior to screen display.

After the main CPU 1 has started execution of the startup program, the initial setting and tests of the respective devices are sequentially executed. In this event, the main CPU 1 sequentially notifies executing contents in detail to the sub-CPU 6 and, in addition, simultaneously notifies time information at corresponding time points to the sub-CPU 6. That is, the main CPU 1 sequentially produces item information indicating executing contents and corresponding time points and provides them to the sub-CPU 6. For example, it is assumed that an operation mode A is set as initial setting of an operation mode of a certain device. It is further assumed that when the operation mode A is set, another circuit state is switched from state X to state Y. The startup program detects switching of the circuit state from state X to state Y after setting the operation mode A.

As an example, a description will be given of setting of a general-purpose I/O port which is generally used. At first, it is assumed that, in a state immediately after resetting the system, the general-purpose I/O port is set as an input port based on a specification thereof. Herein, if the circuit is designed to use this port in the output mode, it is necessary to set this port to the output mode on the startup program for enabling the system to function. After setting to the output mode, the port output value should change according to a value written by the main CPU 1. Therefore, the main CPU 1 writes a proper value after setting to the output mode, reads a state thereof by the main CPU 1 itself, and compares write data and read data. If these data agree with each other, it can be judged that the general-purpose I/O port is set correctly. Devices having various functions are mounted in a general computer system. Detection methods for those devices are varied and it is necessary to judge states thereof one by one in the above manner.

As described above, setting information and test result information along with corresponding time information are successively notified to the sub-CPU 6 as execution information from the main CPU 1. The purpose of transferring the time information is to add additional information such as, for example, whether or not there is regularity in time of failure occurrences or whether or not the program execution interval is abnormally long. The information is notified in a certain message format, but a notification method is not particularly limited.

The sub-CPU 6 successively receives the execution information from the main CPU 1 and, simultaneously, obtains from the A/D converter 9 temperature states on the circuit board 20 and power supply voltage values of the devices as state information indicating states of the computer system, monitors states of signals, such as reset and clock signals, flowing on the circuit board 20 and considered to be important for the system operation, and stores these additional information and the execution information notified from the main CPU 1 collectively into the backup memory 8. That is, while receiving the execution information from the main CPU 1, the sub-CPU 6 processes the state information indicating the states of the computer system and stores the processing results into the backup memory 8. The backup memory 8 has a sufficient capacity so that it can store those operation log information for, for example, several hours.

Herein, if a failure occurs so that subsequent stable operation is not guaranteed, the startup program generally shifts to error processing and thus subsequent processing such as initial setting is not executed. In this event, by causing the sub-CPU 6 to output log information from the backup memory 8 through the communication port 10, it is possible to know what happened until immediately before the occurrence of the failure. Since the backup memory 8 is a backed-up or non-volatile memory, it is also possible to turn off the power of the computer system and to perform analysis in a different place.

There are instances where the computer system normally starts up in the case of a failure of the type that occurs intermittently. In this event, it is also possible to cause the main CPU 1 to obtain log information from the backup memory 8 and to output it through the I/O means 4. Since, as described before, the I/O means 4 is a general input/output circuit, the information may be output by connecting the Ethernet (registered trademark), a USB device, or the like thereto. In this case, it is not necessary to separately prepare an apparatus such as a personal computer for connection to the communication port 10.

As described above, from immediately after the system startup, the main CPU 1 sequentially notifies, in a message format, initialization contents being executed at those time points, test contents after the initialization, and corresponding time information to the sub-CPU 6. While receiving those information, the sub-CPU 6 obtains temperature and voltage information at the respective portions from the A/D converter 9 connected to the sub-CPU 6 and further monitors states of a clock signal, a reset signal, and other control signals important for the system startup, all of which are performed in concurrent processing, and further, the sub-CPU 6 logs the results thereof into the backup memory 8 the contents of which are maintained even if the power supply is disconnected, and outputs log information in the backup memory 8 through the communication port 10 under the control of the sub-CPU 6.

According to this method, even if a failure occurs that is difficult to identify from the exterior because of the occurrence of the failure being in a state before booting of the OS or the like, since there is detailed log information about the occurrence of the failure in correlation with the processing executed at that time point, quick resolution can be achieved. Further, since additional information such as temperature and voltage states of the circuit board 20, that can be one cause for the occurrence of the failure, is also logged, it is possible to immediately know what happened at that time point. Even in a state where some failure occurs in the main CPU 1 itself so that it is not possible to communicate with the sub-CPU 6, the sub-CPU 6 autonomously operates to monitor the operating state and obtain temperature and voltage values and, therefore, it is possible to obtain that state from the communication port 10.

As described above, since the operating state logging monitoring is carried out by the sub-CPU 6 that operates independently of the main CPU 1, it is possible to quickly perform maintenance upon occurrence of a system failure. Further, as compared with the conventional method that outputs only a simple code, it is possible to obtain detailed operation log information and information about an operating environment at the time of the failure occurrence and, therefore, it is possible to quickly identify a cause of the failure occurrence. Further, since the sub-CPU 6 operates independently of the main CPU 1 and autonomously, even if the main CPU 1 cannot operate due to some cause, minimum information such as, for example, temperature and voltage values at the respective elements and states of reset and clock signals at those time points can be obtained and logged. Since those log information can be output through the communication port 10 that operates under the control of the sub-CPU 6, failure analysis is enabled even if the main CPU 1 does not operate at all.

As described above, according to the computer system of FIG. 1, it becomes easy to identify a cause at the time of occurrence of a system failure, particularly, about a problem in a state where the system does not start up at all, and thus it is possible to carry out a failure analysis operation very quickly. Further, since the sub-CPU can operate independently of the main CPU and autonomously, even if the main CPU falls in an operation disabled state, it is possible to output log information from the backup memory. This makes it possible to easily grasp the operating states up to the occurrence of the failure, while, conventionally, when a main CPU falls in an operation disabled state, a debugger also does not operate and thus a failure analysis operation is quite difficult.

Now, an information processing system according to another exemplary embodiment of this invention will be described using a general computer system.

The basic configuration of the computer system described herein is the same as that of the computer system of FIG. 1. In the computer system of FIG. 1, the main CPU 1 communicates operation log information to the sub-CPU 6 per processing of the startup program, while, in this computer system, operation log information is once buffered in a RAM 2 and then DMA-transferred to a sub-CPU 6. For realizing this, for example, a timer is provided on the sub-CPU 6 side and the sub-CPU 6 performs processing of making correspondence between monitoring information and time information added to information transferred from a main CPU 1 through the RAM 2.

The information processing system according to this exemplary embodiment can achieve an operation and effect equivalent to those of the information processing system described in detail using the computer system of FIG. 1.

Various exemplary embodiments of this invention will be enumerated in the following items 1-19.

1. An information processing system comprising:

a main central processing unit (1) that executes processing of object information being a processing object and produces execution information indicating executing contents and a corresponding time point; and

a sub-central processing unit (6) that is connected to the main central processing unit, operates independently of the main central processing unit, and processes state information indicating a state of the information processing system while receiving the execution information.

2. The information processing system according to item 1, wherein the main central processing unit (1) produces the execution information from immediately after the startup of the information processing system.

3. The information processing system according to item 1, further comprising input means (9) connected to the sub-central processing unit (6) for inputting the state information to the sub-central processing unit (6).

4. The information processing system according to item 3, further comprising a circuit board (20), wherein the input means (9) obtains at least one of temperature and voltage at respective portions of the circuit board (20) and produces the state information.

5. The information processing system according to item 1, further comprising a backup memory (8) connected to the sub-central processing unit (6) and adapted to maintain contents even if a power source is disconnected, wherein the sub-central processing unit (6) logs a result of processing the state information into the backup memory (8).

6. The information processing system according to item 5, further comprising a communication port (10) connected to the sub-central processing unit (6), wherein the sub-central processing unit (6) outputs log information in the backup memory (8) through the communication port (10).

7. The information processing system according to item 1, further comprising a non-volatile sub-storage device (7) connected to the sub-central processing unit (6) and storing a control program, wherein the sub-central processing unit (6) operates according to the control program.

8. The information processing system according to item 1, further comprising a main storage device (2) for temporarily storing information necessary for operation of the main central processing unit (1), a non-volatile storage device (3) storing a startup program for the main central processing unit, I/O means (4) for a code produced according to the progress of execution of the startup program by the main central processing unit (1), and display means (5) connected to the I/O means (4) for displaying the code.

9. An information processing method in an information processing system comprising a main central processing unit (1) for processing object information being a processing object, the method comprising:

preparing a sub-central processing unit (6) adapted to operate independently of the main central processing unit (1);

causing the main central processing unit (1) to produce execution information indicating executing contents and a corresponding time point; and

causing the sub-central processing unit (1) to process state information indicating a state of the information processing system while receiving the execution information.

10. The information processing method according to item 9, comprising causing the main central processing unit (1) to produce the execution information from immediately after the startup of the information processing system.

11. The information processing method according to item 9, comprising producing the state information based on at least one of temperature and voltage at respective portions of a circuit board (20) included in the information processing system.

12. The information processing method according to item 9, further comprising:

preparing a backup memory (8) connected to the sub-central processing unit (6) and adapted to maintain contents even if a power source is disconnected; and

causing the sub-central processing unit (6) to log a result of processing the state information into the backup memory (8).

13. The information processing method according to item 9, further comprising causing the sub-central processing unit (6) to output log information in the backup memory (8) through a communication port (10) connected to the sub-central processing unit (6).

14. A computer program for operating an information processing system comprising a main central processing unit (1) for processing object information being a processing object and a sub-central processing unit (6) adapted to operate independently of the main central processing unit (1), the computer program comprising the steps of:

causing the main central processing unit (1) to produce execution information indicating executing contents and a corresponding time point; and

causing the sub-central processing unit (6) to process state information indicating a state of the information processing system while receiving the execution information.

15. The computer program according to item 14, comprising a step of causing the main central processing unit (1) to produce the execution information from immediately after the startup of the information processing system.

16. The computer program according to item 14, wherein the information processing system further comprises a circuit board (20) and input means (9) connected to the sub-central processing unit (6), and the computer program further comprises a step of causing the input means (9) to obtain at least one of temperature and voltage at respective portions of the circuit board (20) and to produce the state information.

17. The computer program according to item 14, wherein the information processing system further comprises a backup memory (8) connected to the sub-central processing unit (6) and adapted to maintain contents even if a power source is disconnected, and the computer program further comprises a step of causing the sub-central processing unit (1) to log a result of processing the state information into the backup memory (8).

18. The computer program according to item 17, further comprising a step of causing the sub-central processing unit (6) to output log information from the backup memory (8).

19. The computer program according to item 14, wherein the information processing system further comprises a non-volatile sub-storage device (7) connected to the sub-central processing unit (6) and storing a control program for operating the sub-central processing unit (1), and the computer program further comprises a step of operating the sub-central processing unit (6) according to the control program.

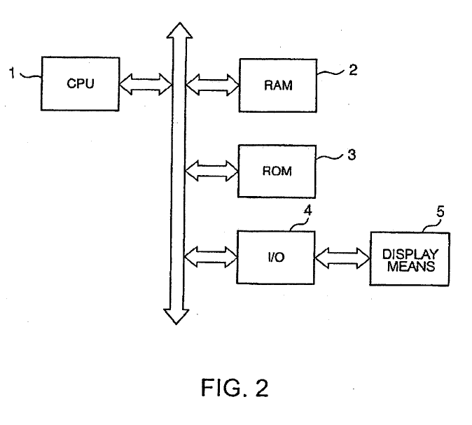

Herein, referring to FIG. 2, an information processing system according to a related art will be described using a general computer system. The illustrated computer system comprises a CPU 11, a RAM 12, a ROM 13, and an I/O 14 and sequentially executes a startup program stored in the ROM 13 after power-on of the system. Normally, such a startup program performs initialization of the respective devices constituting the computer system and conducts a test as to whether or not each device can continue to operate stably and, after the executed contents are all judged to be normal, it transfers the control to an operating system (OS). Thereafter, the computer system continues to operate under the control of the OS.

If, in the above process, a situation occurs where the computer system appears not to be set to an operable state indefinitely as observed from the exterior or, in the case of the computer system being an apparatus having a display, such as a personal computer, a state with no screen display continues as observed from the exterior, notification is made to the exterior as to where a problem exists in the components of the computer system. As a method for the notification, use is made of a technique of outputting a specific value according to the progress of execution of the startup program through the I/O 14 or, at a time point of shifting to error processing, making a corresponding buzzing sound. For example, by outputting values using display means 15 through the I/O 14 such that “01” is displayed upon completion of the initialization of the RAM 12 and “02” is displayed upon completion of the test of the RAM 12, it is possible to notify which of the devices has not been initialized or which of the tests was abnormal. Alternatively, use is made of a technique of making a specific buzzing sound in error processing according to a generated error to thereby giving notification to the exterior as to what error is generated now so that the processing is stopped.

However, it is quite difficult to identify a cause of the failure only based on the above information. For example, when a problem occurs in the RAM 12, while only a phenomenon that NG (failure) has occurred in the memory test is displayed with a simple code, it is often not possible to obtain information about an address value thereof or about what data was written. Further, when there is a problem in the CPU 11 or the I/O 14 itself, the startup is disabled while notification to the exterior cannot be performed at all and thus a long-time analysis operation is required for clearing up the cause.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing system comprising:
a main central processing unit that executes processing of object information being a processing object and produces execution information indicating executing contents and a corresponding time point; and
a sub-central processing unit that is connected to the main central processing unit, operates independently of the main central processing unit, and processes state information indicating a state of the information processing system while receiving the execution information.

2. The information processing system according to claim 1, wherein the main central processing unit produces the execution information from immediately after the startup of the information processing system.

3. The information processing system according to claim 1, further comprising input means connected to the sub-central processing unit for inputting the state information to the sub-central processing unit.

4. The information processing system according to claim 3, further comprising a circuit board, wherein the input means obtains at least one of temperature and voltage at respective portions of the circuit board and produces the state information.

5. The information processing system according to claim 1, further comprising a backup memory connected to the sub-central processing unit and adapted to maintain contents even if a power source is disconnected, wherein the sub-central processing unit logs a result of processing the state information into the backup memory.

6. The information processing system according to claim 5, further comprising a communication port connected to the sub-central processing unit, wherein the sub-central processing unit outputs log information in the backup memory through the communication port.

7. The information processing system according to claim 1, further comprising a non-volatile sub-storage device connected to the sub-central processing unit and storing a control program, wherein the sub-central processing unit operates according to the control program.

8. The information processing system according to claim 1, further comprising a main storage device for temporarily storing information necessary for operation of the main central processing unit, a non-volatile storage device storing a startup program for the main central processing unit, I/O means for a code produced according to the progress of execution of the startup program by the main central processing unit, and display means connected to the I/O means for displaying the code.

9. An information processing method in an information processing system comprising a main central processing unit for processing object information being a processing object, the method comprising:
preparing a sub-central processing unit adapted to operate independently of the main central processing unit;
causing the main central processing unit to produce execution information indicating executing contents and a corresponding time point; and
causing the sub-central processing unit to process state information indicating a state of the information processing system while receiving the execution information.

10. The information processing method according to claim 9, comprising causing the main central processing unit to produce the execution information from immediately after the startup of the information processing system.

11. The information processing method according to claim 9, comprising producing the state information based on at least one of temperature and voltage at respective portions of a circuit board included in the information processing system.

12. The information processing method according to claim 9, further comprising:
preparing a backup memory connected to the sub-central processing unit and adapted to maintain contents even if a power source is disconnected; and
causing the sub-central processing unit to log a result of processing the state information into the backup memory.

13. The information processing method according to claim 9, further comprising causing the sub-central processing unit to output log information in the backup memory through a communication port connected to the sub-central processing unit.

14. A computer program for operating an information processing system comprising a main central processing unit for processing object information being a processing object and a sub-central processing unit adapted to operate independently of the main central processing unit, the computer program comprising the steps of:
causing the main central processing unit to produce execution information indicating executing contents and a corresponding time point; and
causing the sub-central processing unit to process state information indicating a state of the information processing system while receiving the execution information.

15. The computer program according to claim 14, comprising a step of causing the main central processing unit to produce the execution information from immediately after the startup of the information processing system.

16. The computer program according to claim 14, wherein the information processing system further comprises a circuit board and input means connected to the sub-central processing unit, and the computer program further comprises a step of causing the input means to obtain at least one of temperature and voltage at respective portions of the circuit board and to produce the state information.

17. The computer program according to claim 14, wherein the information processing system further comprises a backup memory connected to the sub-central processing unit and adapted to maintain contents even if a power source is disconnected, and the computer program further comprises a step of causing the sub-central processing unit to log a result of processing the state information into the backup memory.

18. The computer program according to claim 17, further comprising a step of causing the sub-central processing unit to output log information from the backup memory.

19. The computer program according to claim 14, wherein the information processing system further comprises a non-volatile sub-storage device connected to the sub-central processing unit and storing a control program for operating the sub-central processing unit, and the computer program further comprises a step of operating the sub-central processing unit according to the control program.
